(19) United States
(12) Patent Application Publication
(10) Pub. No.: US 2009/0206839 A1
(43) Pub. Date: Aug. 20, 2009

(54) SYSTEM, METHOD AND APPARATUS FOR COMPENSATING FOR DRIFT IN A MAIN MAGNETIC FIELD IN AN MRI SYSTEM

(75) Inventors: Derek A. Seeber, Florence, SC (US); Anton M. Linz, Mukwonago, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/034,244

(22) Filed: Feb. 20, 2008

(51) Int. Cl. G01V 3/00; H01F 6/00

(52) U.S. Cl. 324/320; 335/216

(57) ABSTRACT

A method for compensating for drift in a main magnetic field of a superconducting magnet in a magnetic resonance imaging (MRI) system includes measuring a pressure in a cryostat of the superconducting magnet. Based on the pressure, a parameter of an element of the MRI system is adjusted to correct or compensate for a change in the main magnetic field.

### FIELD OF THE INVENTION

The present invention relates generally to a magnetic resonance imaging (MRI) system and in particular to a system, method and apparatus for compensating or correcting for drift (or changes) in a main magnetic field, B₀, based on a pressure in a cryostat during operation of an MRI system.

### BACKGROUND OF THE INVENTION

Magnetic resonance imaging (MRI) is a medical imaging modality that can create pictures of the inside of a human body without using x-rays or other ionizing radiation. MRI uses a powerful magnet to create a strong, uniform, static magnetic field (i.e., the “main magnetic field”). When a human body, or part of a human body, is placed in the main magnetic field, the nuclear spins that are associated with the hydrogen nuclei in tissue water become polarized. This means that the magnetic moments that are associated with these spins become preferentially aligned along the direction of the main magnetic field, resulting in a small net tissue magnetization along that axis (the “z axis,” by convention). An MRI system also comprises components called gradient coils that produce smaller amplitude, spatially varying magnetic fields when a current is applied to them. Typically, gradient coils are designed to produce a magnetic field component that is aligned along the z axis, and that varies linearly in amplitude with position along one of the x, y or z axes. The effect of a gradient coil is to create a small ramp on the magnetic field strength, and concomitantly on the resonant frequency of the nuclear spins, along a single axis. Three gradient coils with orthogonal axes are used to “spatially encode” the MR signal by creating a signature resonance frequency at each location in the body. Radio frequency (RF) coils are used to create pulses of RF energy at or near the resonance frequency of the hydrogen nuclei. The RF coils are used to add energy to the nuclear spin system in a controlled fashion. As the nuclear spins then relax back to their rest energy state, they give up energy in the form of an RF signal. This signal is detected by the MRI system and is transformed into an image using a computer and known reconstruction algorithms.

MRI systems may utilize a superconducting magnet to generate a main magnetic field, B₀. A superconducting magnet includes superconducting coils that are enclosed in a cryogenic environment within a cryostat (or magnet vessel) designed to maintain the temperature of the superconductive coils below an appropriate critical temperature so that the coils are in a superconducting state with zero resistance. Typically, MRI systems require a uniform main magnetic field, B₀, in the imaging volume that should remain homogeneous and constant in time over a wide range of pulse sequences and protocols. Changes or drift in the main magnetic field can affect the performance of the MRI system including data acquisition and reconstruction of an MR image. During a patient scan, the pressure in the cryostat of the superconducting magnet may change, e.g., the pressure may increase or decrease. The change in pressure may be caused by, for example, eddy currents dissipated inside the cryostat. A change in pressure in the cryostat can result in a change or drift in the main magnetic field which in turn can have a negative impact on image quality.

It would be desirable to provide a system, method and apparatus for compensating for the change or drift in the main magnetic field. It would also be desirable to control or compensate for the change or drift of the main magnetic field based on the pressure in the cryostat.

### BRIEF DESCRIPTION OF THE INVENTION

In accordance with an embodiment, a method for compensating for drift in a main magnetic field of a superconducting magnet in a magnetic resonance imaging (MRI) system includes measuring a pressure in a cryostat of the superconducting magnet and adjusting a parameter of an element of the MRI system based on the pressure to correct for a change in the main magnetic field.

In accordance with another embodiment, an apparatus for compensating for drift in a main magnetic field of a superconducting magnet in a magnetic resonance imaging (MRI) system includes at least one pressure sensor coupled to a cryostat of the superconducting magnet, the at least one pressure sensor configured to measure a pressure in the cryostat and to generate a pressure signal, at least one shim coil and a controller coupled to the at least one pressure sensor and the at least one shim coil, the controller configured to control the at least one shim coil to provide a compensation field based on at least the pressure signal.

In accordance with another embodiment, an apparatus for compensating for drift in a main magnetic field of a superconducting magnet in a magnetic resonance imaging (MRI) system includes at least one pressure sensor coupled to a cryostat of the superconducting magnet, the at least one pressure sensor configured to measure a pressure in the cryostat and to generate a pressure signal, a transceiver and a controller coupled to the at least one pressure sensor and the transceiver, the controller configured to control a reference frequency for the transceiver based on at least the pressure signal.

In accordance with another embodiment, a magnetic resonance imaging (MRI) system includes a resonance assembly comprising a superconducting magnet at least one RF coil and at least one shim coil, a transceiver coupled to the resonance assembly, at least one pressure sensor coupled to a cryostat of the superconducting magnet, the at least one pressure sensor configured to measure a pressure in the cryostat and to generate a pressure signal and a controller coupled to the at least one pressure sensor and configured to receive the pressure signal from the at least one pressure sensor and to generate a control signal to control a parameter of an element of the MRI system based on the pressure to correct for a change in a main magnetic field.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a schematic block diagram of an exemplary magnetic resonance imaging (MRI) system in accordance with an embodiment;

FIG. 2 is a cross-sectional side elevation view of a resonance assembly including an apparatus to compensate for drift in a main magnetic field in accordance with an embodiment;

FIG. 3 illustrates a method for compensating for drift in a main magnetic field of a superconducting magnet in an MRI system in accordance with an embodiment;

FIG. 4 is a schematic block diagram of a system for compensating for drift in a main magnetic field of a superconducting magnet in an MRI system in accordance with an embodiment; and

FIG. 5 is a schematic block diagram of a system for compensating for drift in a main magnetic field of a superconducting magnet in an MRI system in accordance with an alternative embodiment.

### DETAILED DESCRIPTION

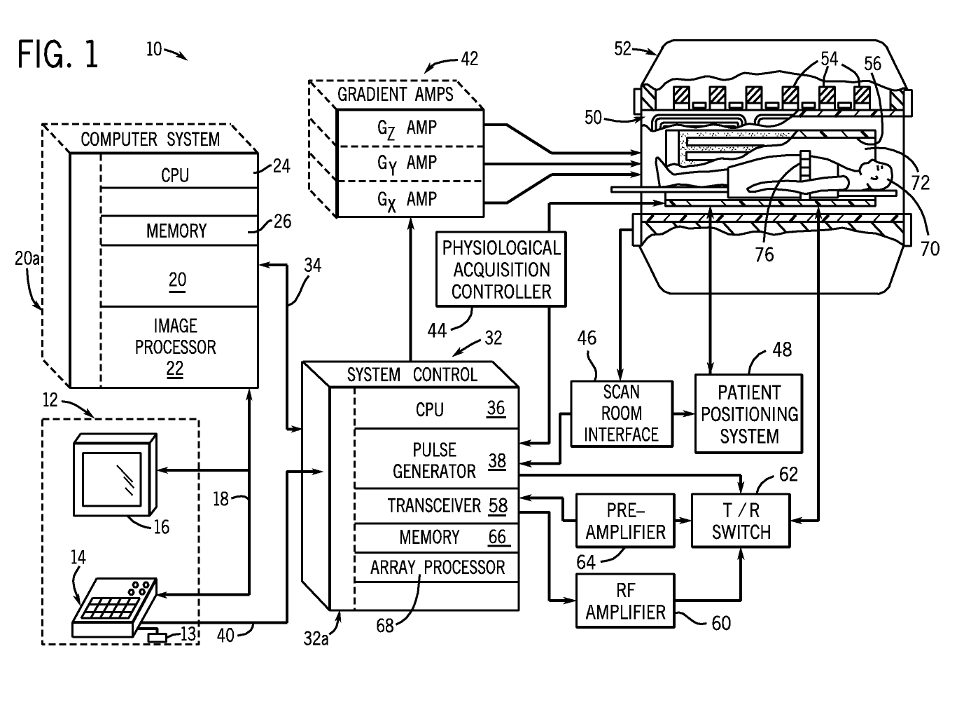

FIG. 1 is a schematic block diagram of an exemplary magnetic resonance imaging (MRI) system in accordance with an embodiment. The operation of MRI system 10 is controlled from an operator console 12 that includes a keyboard or other input device 13, a control panel 14, and a display 16. The console 12 communicates through a link 18 with a computer system 20 and provides an interface for an operator to prescribe MRI scans, display resultant images, perform image processing on the images, and archive data and images. The computer system 20 includes a number of modules that communicate with each other through electrical and/or data connections, for example, such as are provided by using a backplane 20a. Data connections may be direct wired links or may be fiber optic connections or wireless communication links or the like. The modules of the computer system 20 include an image processor module 22, a CPU module 24 and a memory module 26 which may include a frame buffer for storing image data arrays. In an alternative embodiment, the image processor module 22 may be replaced by image processing functionality on the CPU module 24. The computer system 20 is linked to archival media devices, permanent or back-up memory storage or a network. Computer system 20 may also communicate with a separate system control computer 32 through a link 34. The input device 13 can include a mouse, joystick, keyboard, track ball, touch activated screen, light wand, voice control, or any similar or equivalent input device, and may be used for interactive geometry prescription.

The system control computer 32 includes a set of modules in communication with each other via electrical and/or data connections 32a. Data connections 32a may be direct wired links, or may be fiber optic connections or wireless communication links or the like. In alternative embodiments, the modules of computer system 20 and system control computer 32 may be implemented on the same computer system or a plurality of computer systems. The modules of system control computer 32 include a CPU module 36 and a pulse generator module 38 that connects to the operator console 12 through a communications link 40. The pulse generator module 38 may alternatively be integrated into the scanner equipment (e.g., resonance assembly 52). It is through link 40 that the system control computer 32 receives commands from the operator to indicate the scan sequence that is to be performed. The pulse generator module 38 operates the system components that play out (i.e., perform) the desired pulse sequence by sending instructions, commands and/or requests (e.g., radio frequency (RF) waveforms) describing the timing, strength and shape of the RF pulses and pulse sequences to be produced and the timing and length of the data acquisition window. The pulse generator module 38 connects to a gradient amplifier system 42 and produces data called gradient waveforms that control the timing and shape of the gradient pulses that are to be used during the scan. The pulse generator module 38 may also receive patient data from a physiological acquisition controller 44 that receives signals from a number of different sensors connected to the patient, such as ECG signals from electrodes attached to the patient. The pulse generator module 38 connects to a scan room interface circuit 46 that receives signals from various sensors associated with the condition of the patient and the magnet system. It is also through the scan room interface circuit 46 that a patient positioning system 48 receives commands to move the patient table to the desired position for the scan.

The gradient waveforms produced by the pulse generator module 38 are applied to gradient amplifier system 42 which is comprised of Gₓ, G_{y} and G_{z} amplifiers. Each gradient amplifier excites a corresponding physical gradient coil in a gradient coil assembly generally designated 50 to produce the magnetic field gradient pulses used for spatially encoding acquired signals. The gradient coil assembly 50 forms part of a resonance assembly 52 that includes a polarizing superconducting magnet with superconducting main coils 54. Resonance assembly 52 may include a whole-body RF coil 56, surface or parallel imaging coils 76 or both. The coils 56, 76 of the RF coil assembly may be configured for both transmitting and receiving or for transmit-only or receive-only. A patient or imaging subject 70 may be positioned within a cylindrical patient imaging volume 72 of the resonance assembly 52. A transceiver module 58 in the system control computer 32 produces pulses that are amplified by an RF amplifier 60 and coupled to the RF coils 56, 76 by a transmit/receive switch 62. The resulting signals emitted by the excited nuclei in the patient may be sensed by the same RF coil 56 and coupled through the transmit/receive switch 62 to a preamplifier 64. Alternatively, the signals emitted by the excited nuclei may be sensed by separate receive coils such as parallel coils or surface coils 76. The amplified MR signals are demodulated, filtered and digitized in the receiver section of the transceiver 58. The transmit/receive switch 62 is controlled by a signal from the pulse generator module 38 to electrically connect the RF amplifier 60 to the RF coil 56 during the transmit mode and to connect the preamplifier 64 to the RF coil 56 during the receive mode. The transmit/receive switch 62 can also enable a separate RF coil (for example, a parallel or surface coil 76) to be used in either the transmit or receive mode.

The MR signals sensed by the RF coil 56 are digitized by the transceiver module 58 and transferred to a memory module 66 in the system control computer 32. Typically, frames of data corresponding to MR signals are stored temporarily in the memory module 66 until they are subsequently transformed to create images. An array processor 68 uses a known transformation method, most commonly a Fourier transform, to create images from the MR signals. These images are communicated through the link 34 to the computer system 20 where it is stored in memory. In response to commands received from the operator console 12, this image data may be archived in long-term storage or it may be further processed by the image processor 22 and conveyed to the operator console 12 and presented on display 16.

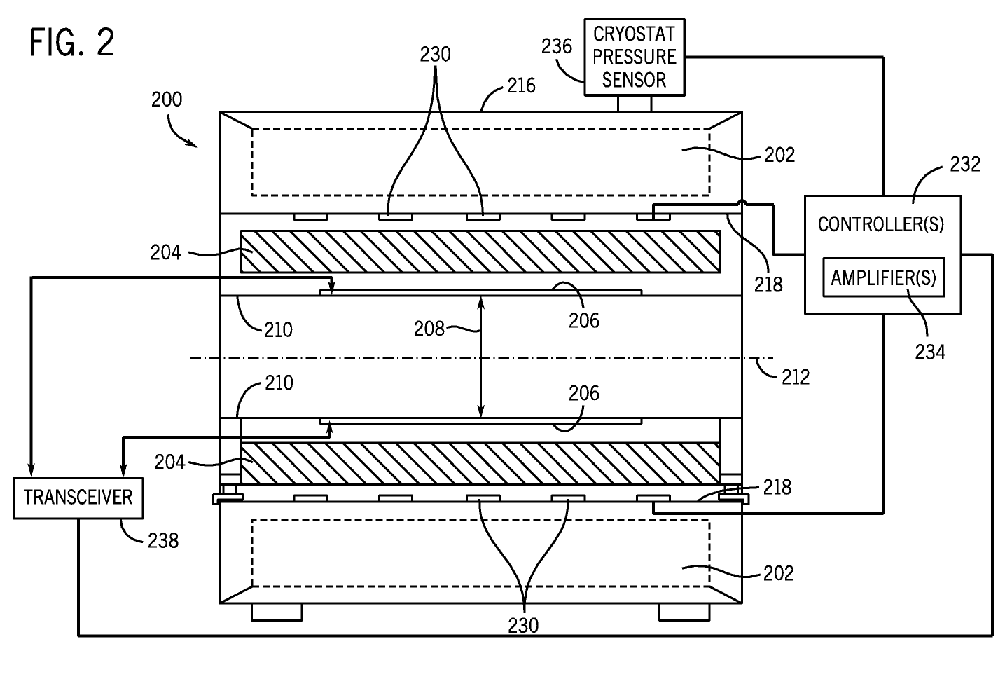

FIG. 2 is a schematic cross-sectional side elevation view of a resonance assembly including an apparatus to compensate for drift in a main magnetic field in accordance with an embodiment. Resonance assembly 200 is cylindrical and annular in shape and is compatible with the above-described MRI system of FIG. 1 or any similar or equivalent system for obtaining MR images. While the following describes a cylindrical resonance assembly topology, it should be understood that other resonance assembly topologies may utilize the embodiments of the invention described herein. Resonance assembly 200 includes, among other elements or components, a superconducting magnet 202, a gradient coil assembly 204 and an RF coil 206. Various other elements, such as magnet coils, cryostat elements, supports, suspension members, end caps, brackets, etc. are omitted from FIG. 2 for clarity. A cylindrical patient volume or space 208 is surrounded by a patient bore tube 210. RF coil 206 is mounted on an outer surface of the patient bore tube 210 and mounted inside the gradient coil assembly 204. The gradient coil assembly 204 is disposed around the RF coil 206 in a spaced apart coaxial relationship and the gradient coil assembly 204 circumferentially surrounds the RF coil 206. Gradient coil assembly 204 is mounted inside a warm bore 218 of the magnet 202 and is circumferentially surrounded by magnet 202.

A patient or imaging subject 70 (shown in FIG. 1) may be inserted into the resonance assembly 200 along a center axis 212 (e.g., a z-axis) on a patient table or cradle (not shown in FIG. 2). Center axis 212 is aligned along the tube axis of the resonance assembly 200 parallel to the direction of the main magnetic field, B₀, generated by the magnet 202. RF coil 206 is used to apply a radio frequency pulse (or a plurality of pulses) to a patient or subject and to receive MR information back from the subject. Gradient coil assembly 204 generates time dependent gradient magnetic pulses that are used to spatially encode points in the imaging volume 208.

Superconducting magnet 202 includes several radially aligned and longitudinally spaced-apart superconductive main coils (not shown), each capable of carrying a large electric current. The superconductive main coils are designed to create a magnetic field, B₀, within the patient volume 208. Superconducting magnet 202 is enclosed in a cryogenic environment within a cryostat 216 (or magnet vessel) designed to maintain the temperature of the superconductive coils below the appropriate critical temperature so that the coils are in a superconducting state with zero resistance. Cryostat 216 may include, for example, a helium vessel and thermal or cold shields for containing and cooling the magnet coils in a known manner. The warm bore 218 is defined by an inner cylindrical surface of the cryostat 216 and is typically made of metal such as stainless steel.

Resonance module 200 may also include shim coils 230, for example, active resistive shim coils. The shim coils 230 are configured to provide compensation (e.g., compensating magnetic fields) for inhomogeneities in the main magnetic field, B₀. The shim coils 230 may include, for example, second order or higher resistive shim coils. In FIG. 2, the shim coils 230 are shown located at a radius within the resonance assembly 200 such that the warm bore 218 is disposed around the shim coils 230 and the shim coils 230 are disposed around the gradient coil assembly 204. In an alternative embodiment, the shim coils 230 may be positioned inside the gradient coil assembly 204 in a known manner. For example, in an embodiment where the gradient coil assembly 204 is a shielded gradient coil assembly consisting of an inner gradient coil assembly and an outer gradient coil assembly, the shim coils may be located at a radius in a volume or space between the inner gradient coil assembly and the outer gradient coil assembly.

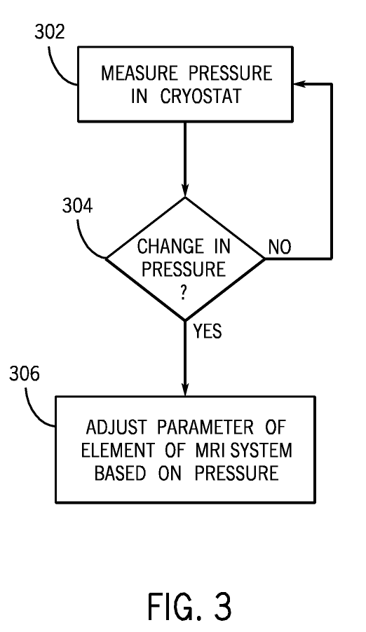

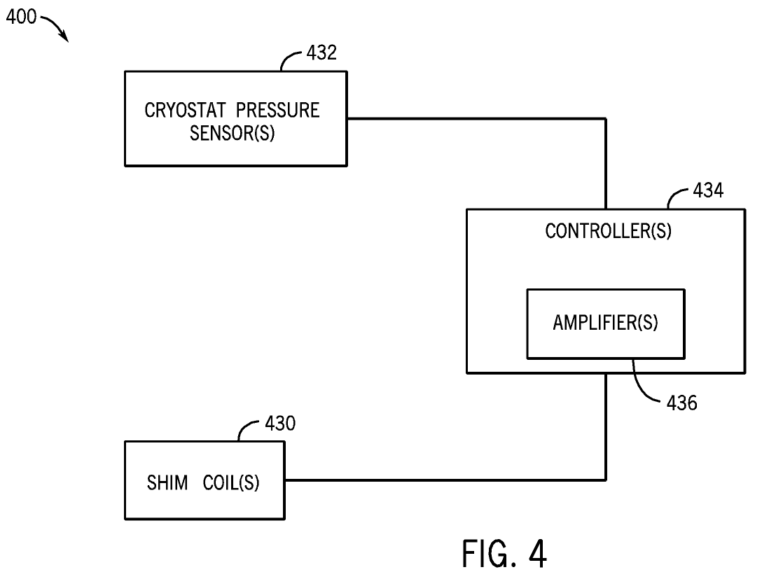

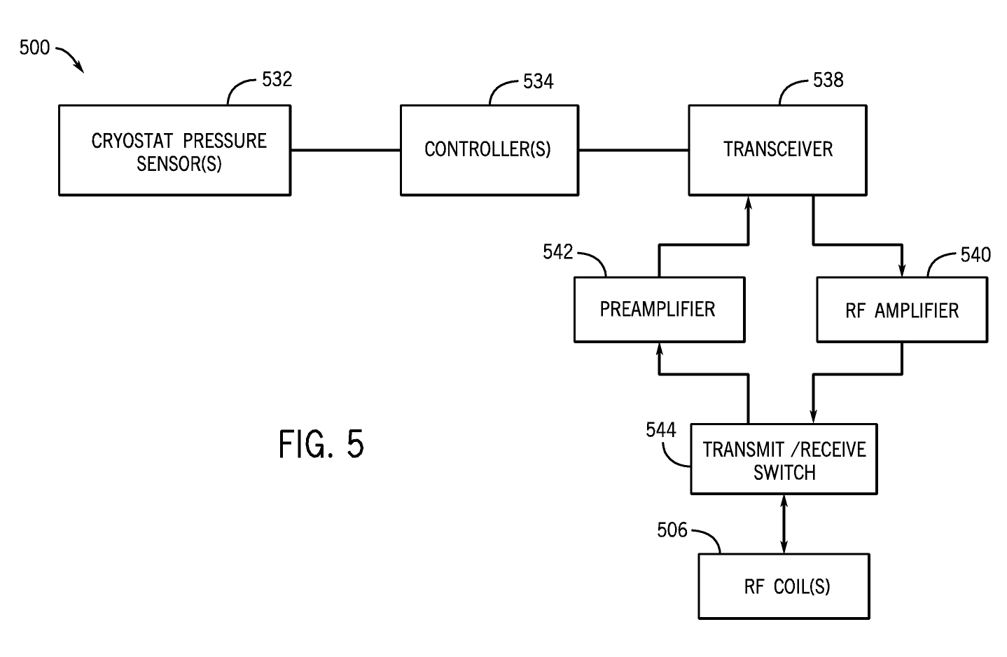

A cryostat pressure sensor (or sensors) 232 is coupled to the cryostat 216 of the resonance assembly 200 and is configured to measure the pressure within the cryostat 216. The pressure sensor may be a pressure sensor known in the art (such as a pressure transducer including a diaphragm and electrical network of strain gauges) and may be connected to the cryostat using methods known in the art. The pressure sensor 232 is also coupled to a controller or controllers 234 (e.g., computer 20 or system control 32 shown in FIG. 1). To control (e.g., to minimize) the change or drift in the main magnetic field resulting from a pressure change (e.g., an increase or decrease in pressure) in the cryostat 216, the pressure sensor 232 readings are provided as an input to controller 234. Based on the cryostat pressure, controller 234 controls an element or component (e.g., a parameter of the element or component) of resonance assembly 200 or MRI system 10 (shown in FIG. 1) to compensate for B₀ drift caused by the change in pressure. In one embodiment, controller 234 is coupled to the shim coils 230 and is configured to control the current supplied to the shim coils 230 to provide the appropriate compensation or correction (e.g., via a compensating magnetic field) of the main magnetic field based on a pressure change as described further below with respect to FIGS. 3 and 4. Controller 234 may include an amplifier (or amplifiers) 236 that is coupled to the shim coils 230 and used to provide a current to the shim coils 230. Alternatively, amplifier 236 may be separate from (i.e., not incorporated within) controller 234. In an alternative embodiment, controller 234 is coupled to a transceiver 238 (e.g., transceiver 58 shown in FIG. 1) which is in turn coupled to the RF coil 206. Various other elements in the transmit and receive paths between transceiver 238 and RF coil 206, such as a RF amplifier, a preamplifier and a transmit/receive switch, are omitted from FIG. 2 for clarity. Controller 234 is configured to control (e.g., adjust) a reference frequency used by transceiver 238 for modulation of the RF signals (or waveforms) transmitted by the RF coil 206 and for demodulation of the RF signals received by the RF coil 206. Drift in the main magnetic field caused by a change in pressure may be corrected by adjusting the reference frequency (e.g., by providing a reference frequency offset) as described further below with respect to FIGS. 3 and 5.

FIG. 3 illustrates a method for compensating for drift in a main magnetic field of a superconducting magnet in an MRI system in accordance with an embodiment. At block 302, the pressure in the cryostat of the superconducting magnet is measured. If there is no change in the pressure at block 304, the cryostat pressure continues to be measured and monitored at block 302. If there is a change in pressure at block 304, a parameter of an element or component of the MRI system is adjusted at block 306 based on the pressure to correct for drift in the main magnetic field. In one embodiment, a current provided to shim coils is adjusted to provide the compensation or correction in the main magnetic field based on the pressure in the cryostat. FIG. 4 is a schematic block diagram of a system for compensating for drift in a main magnetic field of a superconducting magnet in an MRI system in accordance with an embodiment. System 400 is compatible with the resonance assembly and MRI system described above with respect to FIGS. 1 and 2 or any similar or equivalent resonance assembly and MRI system. System 400 includes shim coils 430, at least one cryostat pressure sensor 432, at least one controller 434, and at least one amplifier 436. The cryostat pressure sensor 432 is coupled to the cryostat of a resonance assembly as described above with respect to FIG. 2. Cryostat pressure sensor 432 is configured to measure the pressure in the cryostat during operation of the MRI system (e.g., the playing out of MRI pulse sequences) and to provide a signal or signals to a controller 434 to indicate the pressure within the cryostat.

Controller 434 may be, for example, a computer system 20 (shown in FIG. 1) or a system control 32 (shown in FIG. 1) of the MRI system. Controller 434 is coupled to the shim coils 430. Controller 434 is configured to monitor the pressure of the cryostat (e.g., based on the pressure measurements of the cryostat pressure sensor 432) and to control the shim coils 430 to compensate for drift in the main magnetic field. If a change in pressure in the cryostat is detected based on the signals provided by the cryostat pressure sensor 432, the controller 434 provides a control signal (or signals) to control the amount of compensating field provided by the shim coils 430. In one embodiment, controller 434 provides a control signal to an amplifier (or amplifiers) 436 to adjust or change the current provided to the shim coils 430. Accordingly, the current provided to the shim coils 430 may be adjusted to compensate for (or correct) the effects (e.g., drift) on the main magnetic field caused by the change in pressure in the cryostat.

Returning to FIG. 3, in an alternative embodiment, a reference frequency for the transceiver is adjusted to compensate for (or correct for) the change in the main magnetic field based on the pressure in the cryostat. FIG. 5 is a schematic block diagram of a system for compensating for drift in a main magnetic field of a superconducting magnet in an MRI system in accordance with an alternative embodiment. System 500 is compatible with the resonance assembly and MRI system described above with respect to FIGS. 1 and 2 or any similar or equivalent resonance assembly and MRI system. System 500 includes RF coil(s) 506, at least one cryostat pressure sensor 532, at least one controller 534, a transceiver 538, an RF amplifier 540, a preamplifier 542 and a transmit/receive switch 544. The cryostat pressure sensor 532 is coupled to the cryostat of a resonance assembly as described above with respect to FIG. 2. Cryostat pressure sensor 532 is configured to measure the pressure in the cryostat during operation of the MRI system (e.g., the playing out of MRI pulse sequences) and to provide a signal or signals to a controller 534 to indicate the pressure within the cryostat.

Controller 534 may be, for example, a computer system 20 (shown in FIG. 1) or a system control 32 (shown in FIG. 1) of the MRI system. Controller 534 is coupled to a transceiver 538, an RF amplifier 540, a preamplifier 542, a transmit/receive switch 544 and an RF coil 506. Controller 534 is configured to monitor the pressure of the cryostat (e.g., based on the pressure measurements of the cryostat pressure sensor 532) and to control the transceiver 538 to compensate for (or correct for) drift of the main magnetic field. If a change in pressure in the cryostat is detected based on the signals provided by the cryostat pressure sensor 532, the controller 534 provides a control signal (or signals) to transceiver 538 to adjust a reference frequency used for transmission and reception of RF signals. For example, a reference frequency offset (generated based on the cryostat pressure) may be provided from controller 534 to transceiver 536 to adjust the reference frequency. Accordingly, the reference frequency for transceiver 538 may be adjusted to compensate for (or correct for) drift of the main magnetic field caused by a change in pressure in the cryostat. During a transmit mode, transceiver 538 uses the reference frequency to modulate signals provided to the RF amplifier 540 for amplification and then supplied to the RF coil 506 for transmission. During a receive mode the transceiver 538 uses the reference frequency to demodulate the RF signals received by the RF coil 506 and amplified by the preamplifier 542. As discussed above with respect to FIG. 1, the transmit/receive switch 544 is controlled to connect the RF amplifier 540 to the RF coil 506 during the transmit mode and to connect the preamplifier 542 to the RF coil during the receive mode.

Computer-executable instructions for compensating for drift in a main magnetic field according to the above-described method may be stored on a form of computer readable media. Computer readable media includes volatile and nonvolatile, removable and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium which can be used to store the desired instructions and which may be accessed by MRI system 10 (shown in FIG. 1), including by internet or other computer network forms of access.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order and sequence of any process or method steps may be varied or re-sequenced according to alternative embodiments.

Many other changes and modifications may be made to the present invention without departing from the spirit thereof. The scope of these and other changes will become apparent from the appended claims.

What is claimed is:

1. A method for compensating for drift in a main magnetic field of a superconducting magnet in a magnetic resonance imaging (MRI) system, the method comprising:
measuring a pressure in a cryostat of the superconducting magnet; and
adjusting a parameter of an element of the MRI system based on the pressure to correct for a change in the main magnetic field.

2. A method according to claim 1, wherein adjusting a parameter of an element of the MRI system comprises adjusting a current provided to a shim coil based on the pressure.

3. A method according to claim 1, wherein adjusting a parameter of an element of the MRI system comprises adjusting a reference frequency for a transceiver based on the pressure.

4. A method according to claim 2, wherein the shim coil generates a compensation field based on the adjusted current.

5. An apparatus for compensating for drift in a main magnetic field of a superconducting magnet in a magnetic resonance imaging (MRI) system, the apparatus comprising:
at least one pressure sensor coupled to a cryostat of the superconducting magnet, the at least one pressure sensor configured to measure a pressure in the cryostat and to generate a pressure signal;
at least one shim coil; and
a controller coupled to the at least one pressure sensor and the at least one shim coil, the controller configured to control the at least one shim coil to provide a compensation field based on at least the pressure signal.

6. An apparatus according to claim 5, wherein the at least one shim coil is a resistive shim coil.

7. An apparatus according to claim 5, further comprising at least one amplifier coupled to the controller and the at least one shim coil.

8. An apparatus according to claim 7, wherein the at least one amplifier receives a control signal from the controller, the control signal generated based on the pressure signal.

9. An apparatus according to claim 8, wherein, in response to the control signal, the at least one amplifier adjusts a current provided to the at least one shim coil.

10. An apparatus for compensating for drift in a main magnetic field of a superconducting magnet in a magnetic resonance imaging (MRI) system, the apparatus comprising:
at least one pressure sensor coupled to a cryostat of the superconducting magnet, the at least one pressure sensor configured to measure a pressure in the cryostat and to generate a pressure signal;
a transceiver; and
a controller coupled to the at least one pressure sensor and the transceiver, the controller configured to control a reference frequency for the transceiver based on at least the pressure signal.

11. An apparatus according to claim 10, wherein the transceiver receives a control signal from the controller, the control signal generated based on the pressure signal.

12. An apparatus according to claim 11, wherein, in response to the control signal, the transceiver adjusts the reference frequency.

13. An apparatus according to claim 10, further comprising an RF coil coupled to the transceiver and configured to transmit at least one RF signal based on the reference frequency.

14. A magnetic resonance imaging (MRI) system comprising:
a resonance assembly comprising a superconducting magnet at least one RF coil and at least one shim coil;
a transceiver coupled to the resonance assembly;
at least one pressure sensor coupled to a cryostat of the superconducting magnet, the at least one pressure sensor configured to measure a pressure in the cryostat and to generate a pressure signal; and
a controller coupled to the at least one pressure sensor and configured to receive the pressure signal from the at least one pressure sensor and to generate a control signal to control a parameter of an element of the MRI system based on the pressure to correct for a change in a main magnetic field.

15. A MRI system according to claim 14, wherein the controller is coupled to the at least one shim coil and is configured to control a current provided to the shim coil based on the pressure.

16. An MRI system according to claim 15, wherein current provided to the at least one shim coil is adjusted based on the pressure.

17. An MRI system according to claim 14, wherein the controller is coupled to the transceiver and is configured to control a reference frequency for the transceiver.

18. An MRI system according to claim 17, wherein the reference frequency is adjusted based on the pressure.
